(19) United States
(12) Patent Application Publication
(10) Pub. No.: US 2022/0287234 A1
(43) Pub. Date: Sep. 15, 2022

(54) LAWN MOWER AND HANDLE THEREOF

(71) Applicant: Honda Motor Co., Ltd., Tokyo (JP)

(72) Inventor: Eric WRASE, Offenbach/Main (DE)

(73) Assignee: Honda Motor Co., Ltd., Tokyo (JP)

(21) Appl. No.: 17/200,898

(22) Filed: Mar. 14, 2021

(51) Int. Cl. A01D 34/82; A01D 34/68

(52) U.S. Cl. CPC A01D 34/824; A01D 34/6806; A01D 2034/6843; A01D 2101/00

(57) ABSTRACT

A lawn mower adapted to be stood in an upright position by a front end of the lawn mower and a handle of the lawn mower is provided. The lawn mower includes a frame, a working part, the handle and a rotating part. The working part includes a cutter blade disposed rotatably inside the frame. The rotating part includes, a pivot point, configured to fold the handle over the frame by rotating the handle with respect to the frame. The handle includes an operation part adapted for a user to operate the working part, and a length between the operation part and the rotating part is less than a length between the handle and the rotating part.

### BACKGROUND

### Technical Field

The disclosure relates to a lawn mower, and more specifically relates to a handle of the lawn mower for storing the lawn mower in an upright position (rear side up).

### Description of Related Art

Conventionally, storing a lawn mower in a horizontal position (a normal operating position of the lawn mower) requires a lot of space, and additional storage space is necessary to accommodate a grassbag of the lawn mower.

Therefore, there is a need to securely store the lawn mower without taking up a large storage space. Furthermore, there is a need to store the lawn mower in a way which is easy and which does not require much effort.

### SUMMARY

According to an embodiment of the disclosure, a lawn mower adapted to be stood in an upright position by a front end of the lawn mower and a handle of the lawn mower is provided. The lawn mower includes a frame, a working part, the handle and a rotating part. The working part includes a cutter blade disposed rotatably inside the frame. The rotating part includes, a pivot point, configured to fold the handle over the frame by rotating the handle with respect to the frame. The handle includes an operation part adapted for a user to operate the working part, and a length between the operation part and the rotating part is less than a length between the handle and the rotating part.

According to an embodiment of the disclosure, the handle further includes a gripping rod protruding from the handle at the rotating part, in a direction opposite to the operation part.

According to an embodiment of the disclosure, the lawn mower further has a driving part including an engine, wherein in a non-upright position of the lawn mower, the driving part is disposed on an upper side of the frame, wherein the rotating part is provided on the frame at a position closer to a driving part side than a working part side.

According to an embodiment of the disclosure, an engine handle is provided on a casing that encloses the engine.

According to an embodiment of the disclosure, in the non-upright position of the lawn mower, the working part is disposed on a lower side of the frame.

According to an embodiment of the disclosure, a first tire and a second tire are disposed on the front end of the lawn mower, and in the upright position of the lawn mower, the first tire, the second tire and a ground contacting part of the handle are configured to make contact with a ground.

According to an embodiment of the disclosure, the rotating part further has a control part including a circuit, and in a folded state of the handle, the control part prevents a turning-on of the drive part, or blocks an output of the operation part.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures.

FIG. 1 is a perspective view diagram illustrating a lawn mower according to an embodiment of the disclosure.

FIG. 2 is a partial view of a working part of a lawn mower according to an embodiment of the disclosure.

FIG. 3 is a schematic diagram illustrating a side view of a lawn mower in which the handle is in a non-folded state according to an embodiment of the disclosure.

FIG. 4 is a schematic diagram illustrating a side view of a lawn mower in which the handle is in a folded state according to an embodiment of the disclosure.

FIG. 5 is a schematic diagram illustrating a top view of the lawn mower in which the handle is in a folded state according to an embodiment of the disclosure.

FIG. 6 is a schematic diagram illustrating a side view of the lawn mower in which the lawn mower is stood in an upright position by a front end of the lawn mower and a handle of the lawn mower according to an embodiment of the disclosure.

FIG. 7 is a schematic diagram illustrating a lawn mower having additional gripping handles according to an embodiment of the disclosure.

FIG. 8 is a perspective view diagram illustrating a lawn mower having a handle according to another embodiment of the disclosure.

### DESCRIPTION OF THE EMBODIMENTS

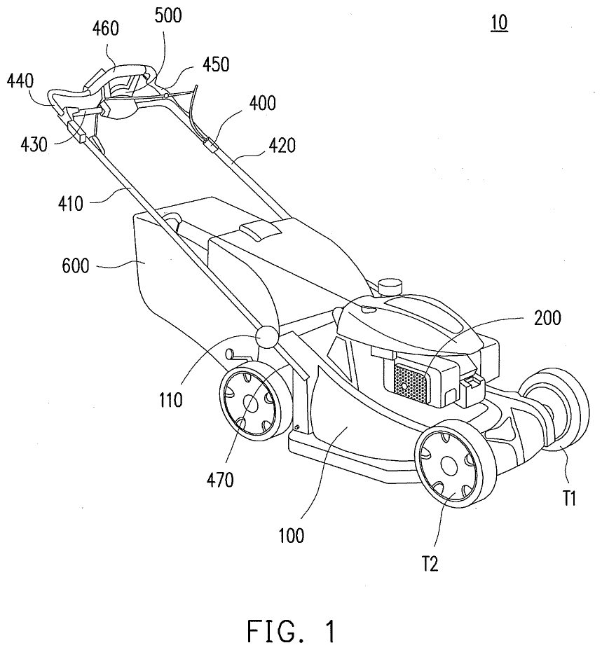

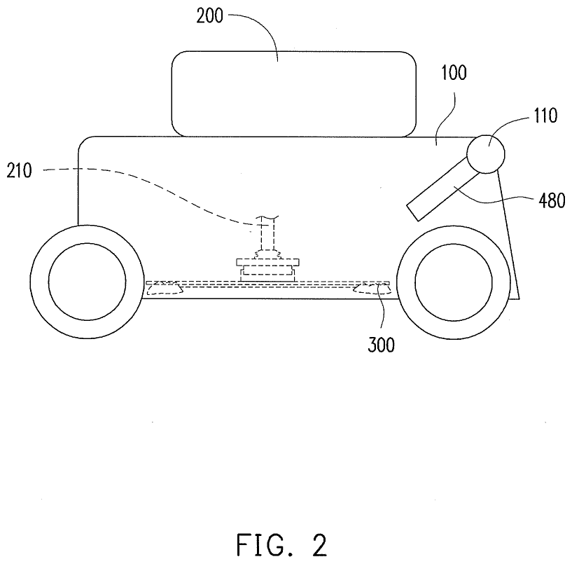

According to an exemplary embodiment of the disclosure, a lawn mower is provided. FIG. 1 is a perspective view diagram schematically illustrating a lawn mower according to an embodiment of the disclosure. FIG. 2 is a partial view of a working part of a lawn mower according to an embodiment of the disclosure.

Referring to FIG. 1 and FIG. 2, a lawn mower 10 is adapted to be stood in an upright position by a front end of the lawn mower and a handle of the lawn mower. The lawn mower 10 includes a frame 100, an engine 200 and a cutter blade 300. The engine 200 is an example of a driving part. The engine 200 may be a gas engine or an electric motor, and the type of engine or motor is not intended to limit the disclosure. The engine 200 is disposed on one side of the frame 100. In the present embodiment, the one side is an upper side of the frame 100. The cutter blade 300 is disposed on another side of the frame 100. In the present embodiment, the another side is a lower side of the frame 100. Furthermore, the another side of the frame 100 is a side opposite to the one side of the frame 100.

The cutter blade 300 is an example of a working part. The cutter blade 300 is disposed rotatably inside the frame 100. The cutter blade 300 is coupled to an output shaft 210 of the engine 200. The cutter blade 300 is adapted to cut grass.

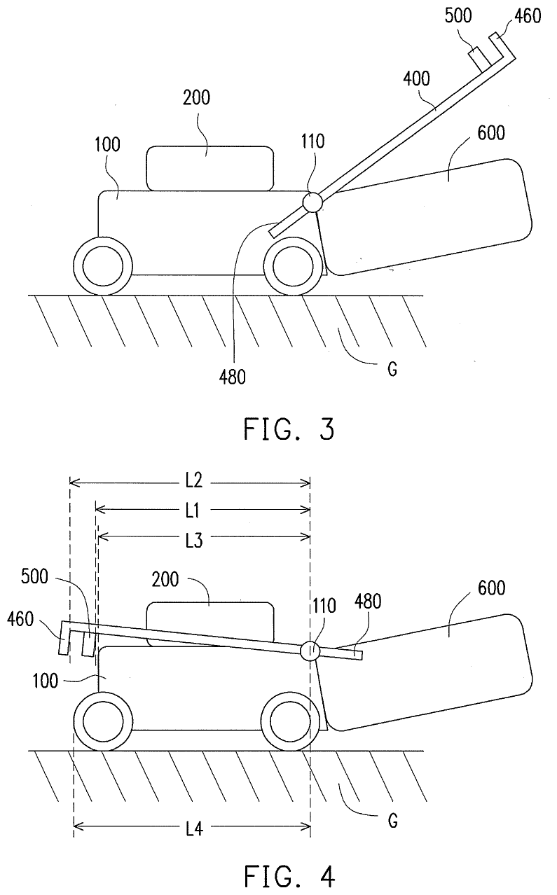

FIG. 3 is a schematic diagram illustrating a side view of a lawn mower in which the handle is in a non-folded state according to an embodiment of the disclosure. The “side view” refers to a viewing direction along an axial direction of the tires T1, T2 of the lawn mower 10. Referring to FIG. 3, the lawn mower 10 further includes a handle 400. The handle 400 includes an operation part 500 having a switch, and is adapted for a user to operate the cutter blade 300. The switch may be a mechanical switch or an electrical switch, and the type of switch is not intended to limit the disclosure. The frame 100 further includes a pivot point 110. The pivot point 110 is an example of a rotating part of the present disclosure. The pivot point 110 is configured such that the handle 400 may be folded over the frame 100 by rotating the handle 400 with respect to the frame 100. In other words, the handle 400 is rotatable about the pivot point 110 such that the handle 400 may be folded onto the frame 100.

In the present embodiment, the rotating part may further include a locking pin to lock the handle 400 with the frame 100 in the folded state or the extended state of the handle 400. However, the disclosure is not limited thereto, and other locking mechanisms may be substituted for the locking pin for locking the handle 400 with respect to the frame 100.

FIG. 4 is a schematic diagram illustrating a side view of a lawn mower in which the handle is in a folded state according to an embodiment of the disclosure. The “side view” refers to a viewing direction along an axial direction of the tires T1, T2. Referring to FIG. 4, when the handle is in a folded state, a dimension of the lawn mower 10 is reduced.

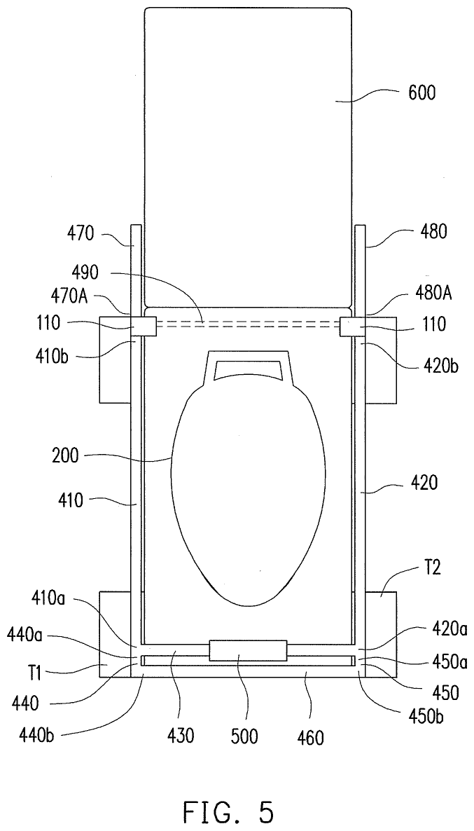

FIG. 5 is a schematic diagram illustrating a top view of the lawn mower in which the handle is in a folded state according to an embodiment of the disclosure. Referring to FIG. 5, the handle 400 includes a first shaft 410 and a second shaft 420. The first shaft 410 has a first end 410a and a second end 410b. The second shaft 420 has a first end 420a and a second end 420b. A first connecting member 430 connects the first end 410a of the first shaft 410 with the first end 420a of the second shaft 420. The operation part 500 is disposed on the first connecting member 430.

The handle 400 further includes a third shaft 440 and a fourth shaft 450. The third shaft 440 has a first end 440a connecting to at least one of the first end 410a of the first shaft 410 or the first connecting member 430. A second end 440b of the third shaft 440 extends in a direction away from the second end 410a of the first shaft 410. The fourth shaft 450 has a first end 450a connecting to at least one of the first end 420a of the second shaft 420 or the first connecting member 430. A second end 450b of the fourth shaft 450 extends in a direction away from the second end 420b of the second shaft 420. In the present embodiment, the first end 440a of the third shaft 440 is connected to the first end 410a of the first shaft 410, and not connected to the first connecting member 430. In addition, the first end 450a of the fourth shaft 450 is connected to the first end 420a of the second shaft 420, and not connected to the first connecting member 430. However, in other embodiments of the disclosure, the first end 440a of the third shaft 440 may be connected to the first connecting member 430, or both the first end 410a of the first shaft 410 and the first connecting member 430. Similarly, the first end 450a of the fourth shaft 450 may be connected to the first connecting member 430, or both the first end 420a of the second shaft 420 and the first connecting member 430. A second connecting member 460 connects the second end 440b of the third shaft 440 with the second end 450b of the fourth shaft 450. The second end 410b of the first shaft 410 is rotatably coupled to the pivot point 110 of the frame 100. The second end 420b of the second shaft 420 is rotatably coupled to pivot point 110 of the frame 100.

Referring to FIG. 1, in the present embodiment, an imaginary axial line of the first shaft 410 and an imaginary axial line of the third shaft 440 intersect to form an obtuse angle. In addition, an imaginary axial line of the second shaft 420 and an imaginary axial line of the fourth shaft 450 intersect to form an obtuse angle. In this way, when the lawn mower 10 is viewed in the axial direction of the tires T1, T2 as shown in FIG. 4, a length L1 between the pivot point 110 and the operation part 500 is less than a length L2 between the pivot point 110 and the second connecting member 460 of the handle 400.

The handle 400 may further include a third connecting shaft 490 connecting the second end 410b of the first shaft 410 with the second end 420b of the second shaft 420. The third connecting shaft may be disposed connecting the two pivot points 110 of the frame 100. In other words, the third connecting shaft 490 passes through the two pivot points 110 of the frame 100. Additionally, bearings (not shown) may be used to facilitate the rotation of the handle 400 about the pivot points 110.

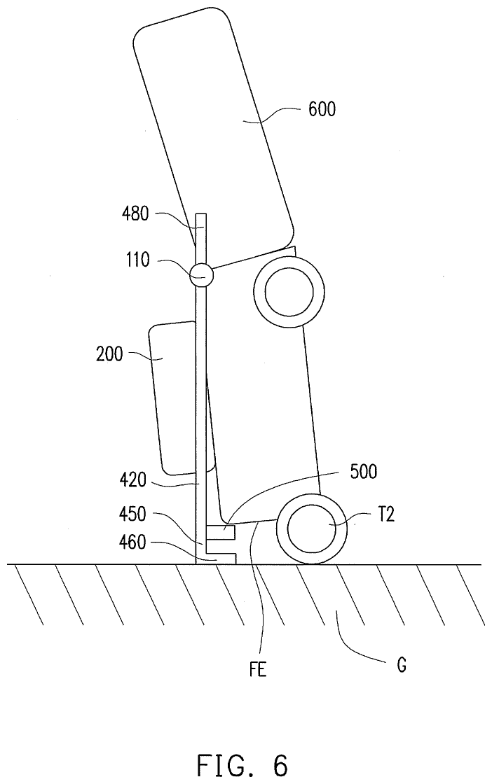

FIG. 6 is a schematic diagram illustrating a side view of the lawn mower in which the lawn mower is stood in an upright position by a front end of the lawn mower and a handle of the lawn mower according to an embodiment of the disclosure. Referring to FIG. 6, since the length L2 between the pivot point 110 and the second connecting member 460 is greater than the length L1 between the pivot point 110 and the operation part 500, therefore when the lawn mower 10 is stood in the upright position by the front end of the lawn mower and the second connecting member 460 of the handle 400, then the operation part 500 does not contact the ground G. In this way, damage to the operation part 500 due to contact with the ground G may be prevented since the operation part 500 does not contact the ground G. In addition, the operating part 500 becoming dirty due to contact with the ground G may be prevented since the operation part 500 does not contact the ground G.

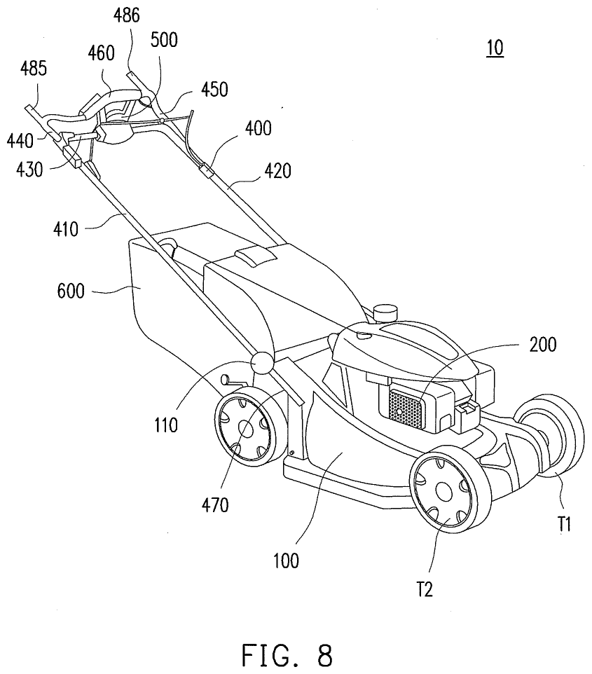

FIG. 8 is a perspective view diagram illustrating a lawn mower having a handle according to another embodiment of the disclosure. Referring to FIG. 8, in another embodiment of the disclosure, the handle 400 may further include a fifth shaft 485 and a fifth shaft 486. The fifth shaft 485 has a first end connecting to at least one of the second end 440b of the third shaft 440 or the second connecting member 460. A second end of the fifth shaft 485 extends in a direction away from the second end 440b of the third shaft 440. The fifth shaft 486 has a first end connecting to at least one of the second end 450b of the fourth shaft 450 or the second connecting member 460. A second end of the fifth shaft 486 extends in a direction away from the second end 450b of the fourth shaft 450. In the present embodiment, the first end of the fifth shaft 485 is connected to the second end 440b of the third shaft 440, and not connected to the second connecting member 460. In addition, the first end of the fifth shaft 486 is connected to the second end 450b of the fourth shaft 450, and not connected to the second connecting member 460. However, in other embodiments of the disclosure, the first end of the fifth shaft 485 may be connected to the second connecting member 460, or both the second end 440b of the third shaft 440 and the second connecting member 460. Similarly, the first end of the fifth shaft 486 may be connected to the second connecting member 460, or both the second end 450b of the fourth shaft 450 and the second connecting member 460.

An imaginary axial line of the third shaft 440 and an imaginary axial line of the fifth shaft 485 intersect to form an obtuse angle. In addition, an imaginary axial line of the fourth shaft 450 and an imaginary axial line of the fifth shaft 486 intersect to form an obtuse angle. In this way, when the lawn mower 10 is viewed in the axial direction of the tires T1, T2 as shown in FIG. 4, a length L1 between the pivot point 110 and the operation part 500 is less than a length L2 between the pivot point 110 and the second connecting member 460 of the handle 400. In this embodiment, the lawn mower 10 is stood in the upright position by the front end of the lawn mower and the fifth shaft 485 and fifth shaft 486 of the handle 400. The operation part 500 and the second connecting member 460 does not contact the ground G. In this way, damage to the operation part 500 and the second connecting member 460 due to contact with the ground G may be prevented since the operation part 500 and the second connecting member do not contact the ground G. In addition, the operating part 500 and the second connecting member 460, where the user may grip the handle 400 during the operation of the lawn mower 10, becoming dirty due to contact with the ground G may be prevented since the operation part 500 does not contact the ground G.

Referring to FIG. 5, the handle 400 further includes a first gripping rod 470 protruding from the second end 410b of the first shaft 410. It should be noted the second end 410b of the first shaft 410 is rotatably coupled to the pivot point 110 of the frame 100. That is to say, the first gripping rod 470 is a portion of the handle 400 protruding at the pivot point 110, in a direction opposite to the operation part 500. In other words, the handle 400 includes the first gripping rod 470 having a first end 470A connecting to the second end 410b of the first shaft 410. In the present embodiment, the first shaft 410 is parallel to the first gripping rod 470. However, in another embodiment of the disclosure, the first shaft 410 and the first gripping rod 470 may form an obtuse angle or an acute angle, and is not intended to limit the disclosure.

Similarly, the handle 400 further includes a second gripping rod 480 protruding from the second end 420b of the second shaft 420. It should be noted the second end 420b of the second shaft 420 is rotatably coupled to the pivot point 110 of the frame 100. That is to say, the second gripping rod 480 is a portion of the handle 400 protruding at the pivot point 110, in a direction opposite to the operation part 500. In other words, the handle 400 includes the second gripping rod 480 having a first end 480A connecting to the second end 420b of the second shaft 420. In the present embodiment, the second shaft 420 may be parallel to the second gripping rod 480. However, in another embodiment of the disclosure, the second shaft 420 and the second gripping rod 480 may form an obtuse angle or an acute angle, and is not intended to limit the disclosure.

Either one or both of the first gripping rod 470 and the second gripping rod 480 may be gripped by the user when moving the lawn mower from the normal operating position to the upright position. It should be noted, in the present embodiment, the pivot point 110 is provided on the frame 100 at a position closer to an engine side than a cutter blade side. In other words, the pivot point 110 is positioned closer to the engine 200 than to the cutter blade 300. In this way, the first gripping rod 470 and the second gripping rod 480 are positioned on the upper side of the frame 100 instead of the lower side of the frame 100. In this way, the user may grip the first gripping rod 470 and the second gripping rod 480 without a need to bend over or squat too deeply when moving the lawn mower 10 from the normal operating position to the upright position. That is, first gripping rod 470 and the second gripping rod 480 positioned on the upper side of the frame 100 instead of the lower side of the frame 100 will be closer to a standing position of the user. In addition, since the engine 200 is a relatively heavy component in the lawn mower 10, by providing the gripping rods 470, 480 at a position closer to the heavy component (engine 200), the user may more easily move the lawn mower 10 from the normal operating position to the upright position because the gripping rods 470, 480 are disposed closer to the center of gravity.

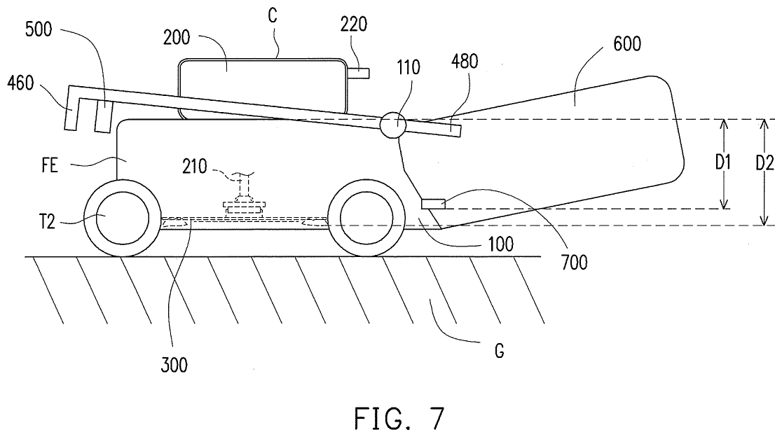

FIG. 7 is a schematic diagram illustrating a lawn mower having additional gripping handles according to an embodiment of the disclosure. Referring to FIG. 7, in an embodiment of the disclosure, an engine handle 220 is provided on a casing C that encloses the engine 200. In more detail, the engine handle 220 is fixed to the casing C. The engine handle 220 extends in a direction substantially orthogonal to an axial direction of the output shaft 210. Since the engine 200 is a relatively heavy component in the lawn mower 10, by providing the engine handle 220 at a position closer to the heavy component (engine 200), the user may more easily move the lawn mower 10 from the normal operating position to the upright position because the engine handle 220 is disposed closer to the center of gravity.

Referring to FIG. 7, in an embodiment of the disclosure a rear handle 700 may be fixed to the frame 100 of the lawn mower 10. In the present embodiment, the rear handle 700 extends in a direction substantially orthogonal to an axial direction of the output shaft 210. However, an extending direction of the rear handle 700 is not limited thereto. In other embodiments, the rear handle 700 may extend at an angle with respect to a direction orthogonal to the axial direction of the out shaft 210. A distance D1 between the engine 200 and the rear handle 700 is less than a distance D2 between the engine 200 and the cutter blade 300. Since the rear handle 700 is located closer to the engine 200 than the cutter blade 300, therefore the rear handle 700 will be provided at a position above the cut grass (grass that is cut). In this way, the rear handle 700 will not press down on the cut grass after cutting because the rear handle 700 is higher than the cut grass. When the distance D1 between the engine 200 and the rear handle 700 is greater than the distance D2 between the engine 200 and the cutter blade 300, then the rear handle 700 will be provided at a position below (lower than) the cut grass, such that the rear handle 700 presses down on the cut grass after cutting. If the handle 700 presses down on the cut grass, then the grass may be damaged or an appearance of the grass may appear to be disorganized to a human eye.

In the present embodiment, in the non-upright position of the lawn mower, the cutter blade 300 (working part) is disposed on a lower side of the frame. Since the engine handle 220, the first gripping rod 470 and the second gripping rod 480 are disposed at a portion close to the engine 200 which is a heavy object, therefore the user may grip a portion that is close to a center of gravity of the lawn mower 10. According to this configuration, the user may easily move the lawn mower 10 from the normal operating position to the upright position.

According to an embodiment of the disclosure, a grassbag frame and its sounding fabric (fabric on the grassbag frame) may remain on the frame 100 of the lawn mower 10 while the lawn mower 10 is rotated to the storage position (upright position) with rear side (grassbag side) up. In another embodiment of the disclosure, the grassbag 600 may be removed from the lawn mower 10, and a configuration of the grassbag 600 is not intended to limit the disclosure.

Referring to FIG. 6 and FIG. 7, the first tire T1 and the second tire T2 are disposed on the front end FE of the lawn mower 10. The front end FE of the lawn mower 10 refers to a leading end of the lawn mower 10 when the lawn mower is mowing grass. In other words, when the handle 400 is folded over the frame 100 about the pivot point 110 in preparation for storage, the second connecting member 460 of the handle 400 will approach the front end FE of the lawn mower 10. The first tire T1 and the second tire T2 are configured to protrude beyond the front end FE of the lawn mower 10. In other words, a diameter of the first tire T1 and a diameter of the second tire T2 protrudes beyond the front end FE of the lawn mower 10. In this way, in the upright position of the lawn mower, the first tire T1, the second tire T2 and a ground contacting part of the handle 400 (the ground contacting part of the handle 400 may be, for example, the fifth shaft 485, the sixth shaft 486, and/or the second connecting member 460 and the like according to the embodiment) are configured to make contact with the ground G. The ground contacting part is, for example, the second connecting member 460 of the handle 400.

That is to say, in the upright position of the lawn mower 10, the first tire T1 and the second tire T2 contact the ground G, however the actual front end FE of the lawn mower 10 does not contact the ground G. In the upright position of the lawn mower, the front end FE of the lawn mower 10 and the operation part 500 disposed on the handle 400 are lifted up above the ground by the first tire T1, the second tire T2 and the second connecting member 460. In this way, damage to the front end FE caused by friction or contact with the ground G may be prevented.

In addition, the handle 400 is shaped so, that the lawn mower 10 may be stood in the upright position on the handle 400 and the front wheels (the first tire T1 and the second tire T2). For example, the second connecting member 460 of the handle 400 may include a bent portion such as shown in FIG. 1. In the embodiment of FIG. 1, the second connecting member 460 includes the bent portion which protrudes (bends) towards a direction substantially perpendicular to the length of the first shaft 410 and the second shaft 420. However, the disclosure is not limited thereto. In another embodiment of the disclosure, the second connecting member 460 may include the bent portion which protrudes (bends) towards the pivot point 110, namely in a direction substantially parallel to the length of the first shaft 410 and the second shaft 420, instead of protruding (bending) towards the direction substantially perpendicular to the length of the first shaft 410 and the second shaft 420. In the embodiment where the bent portion protrudes towards the pivot point 110, a distance between the bent portion and the pivot point 110 may be substantially equal to a distance between the operating part 500 and the pivot point 110. In another embodiment, the second connecting member 460 may include multiple bent portions, such as a first bent portion which protrudes (bends) towards the direction substantially perpendicular to the length of the first shaft 410 and the second shaft 420, and a second bent portion which protrudes (bends) towards the pivot point 110 in the direction substantially parallel to the length of the first shaft 410 and the second shaft 420.

In an embodiment of the disclosure, a length L3 between the pivot point 110 and the front end FE of the lawn mower 10 is less than the length L2 between the pivot point 110 and the second connecting member 460. In addition, the length L3 between the pivot point 110 and the front end FE of the lawn mower 10 is less than a length L4 between the pivot point 110 and a point on the diameter of the first tire T1 (or the second tire T2) protruding beyond the front end FE of the lawn mower 10.

In the upright position of the lawn mower 10, since the lawn mower 10 is configured in way such that the first tire T1 and the second tire T2 contact the ground G, and the front end FE of the lawn mower does not contact the ground G, in this way, when the user desires to transport the lawn mower 10 that is in the upright position, from one location to another, the lawn mower 10 may be tilted onto the tires T1, T2 prior to being moved by the user. Accordingly, the user may lift the handle 400 off the ground to move the lawn mower 10, and damage to the handle 400 caused by friction or contact with the ground G may be prevented. In addition, by tilting the lawn mower 10 onto the tires T1, T2 in the upright position, a direction of the lawn mower 10 may be easily steered by the user.

In an embodiment of the disclosure, the rotating part may further include a control part in addition to the pivot point 110. The control part includes a circuit. The circuit may be, for example, a circuit breaker or the like. The circuit breaker may be electrically connected with the operation part 500 and/or the engine 200. That is to say, in a folded state of the handle 400, or when the handle 400 is not in an extended state, the circuit breaker prevents a turning-on of the drive part (the engine 200), and/or blocks an output of the operation part 500. In other words, when the handle 400 is in the folded state or when the handle 400 is not extended, the circuit breaker cuts off an electrical connection of the operation part 500. In this way, an accidental turn on of the lawn mower 10 when the lawn mower 10 is being stored in the upright position may be prevented. In addition, an accidental turn on of the lawn mower 10 when the handle bar 400 is being folded may be prevented.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A lawn mower, adapted to be stood in an upright position by a front end of the lawn mower and a handle of the lawn mower, the lawn mower comprising:
a frame;
a working part, comprising a cutter blade disposed rotatably inside the frame;
the handle; and
a rotating part, comprising a pivot point, configured to fold the handle over the frame by rotating the handle with respect to the frame,
wherein the handle includes an operation part adapted for a user to operate the working part, and a length between the rotating part and the operation part is less than a length between the rotating part and the handle.

2. The lawn mower according to claim 1, wherein the handle further comprises a gripping rod protruding from the handle at the rotating part, in a direction opposite to the operation part.

3. The lawn mower according to claim 2, further comprising;
a driving part comprising an engine, wherein in a non-upright position of the lawn mower, the driving part is disposed on an upper side of the frame, wherein the rotating part is provided on the frame at a position closer to a driving part side than a working part side.

4. The lawn mower according to claim 3, wherein an engine handle is provided on a casing that encloses the engine.

5. The lawn mower according to claim 3, wherein in the non-upright position of the lawn mower, the working part is disposed on a lower side of the frame.

6. The lawn mower according to claim 1, wherein a first tire and a second tire are disposed on the front end of the lawn mower, and in the upright position of the lawn mower, the first tire, the second tire and a ground contacting part of the handle are configured to make contact with a ground.

7. The lawn mower according to claim 1, wherein the rotating part further includes a control part comprising a circuit, and in a folded state of the handle, the control part prevents a turning-on of the drive part, or blocks an electrical output of the operation part.

8. The lawn mower according to claim 6, wherein a length between the rotating part and a front end of the lawn mower is less than the length between the rotating part and the ground contacting part of the handle.

9. The lawn mower according to claim 6, wherein a diameter of the first tire and a diameter of the second tire protrudes beyond the front end FE of the lawn mower 10.
